(19) United States
(12) Patent Application Publication
(10) Pub. No.: US 2004/0054715 A1
(43) Pub. Date: Mar. 18, 2004

(54) Capturing and replaying internet application transactions using an embedded browser

(76) Inventor: Paul Cesario, Fort Collins, CO (US)

Correspondence Address: AGILENT TECHNOLOGIES, Legal Department, 51U-PD, Intellectual Property Administration, P.O. Box 58043, Santa Clara, CA, 95052-8043, US

(21) Appl. No.: 10/244,195

(22) Filed: Sep. 16, 2002

(51) Int. Cl. G06F 15/173; G09G 5/00; G06F 15/16

(52) U.S. Cl. 709/203; 709/224; 345/738

(57) ABSTRACT

An embedded browser for capturing and replaying Internet application transactions. The system for capturing and replaying Internet application transactions using an embedded browser uses a client browser, coupled to an Internet, and an embedded browser, coupled to the client browser. The embedded browser communicates with a web transaction servlet, coupled to the Internet, where the web transaction servlet is operable to provide a plurality of files required for the correct operation of the embedded browser. The embedded browser accesses web pages from a plurality of web servers coupled to the Internet, wherein each web server of the plurality of web servers contains one or more web pages. The web pages accessed by the user are recorded as a plurality of Internet application transactions, and these transactions may be replayed at a later time using the embedded browser. Transaction data may be captured at both the page and the protocol level to allow full replay of the transaction even if the page layout or content changes. Upon replaying the recorded transactions, measurement statistics related to the transaction and the connection may be compiled. These measurements may be used to evaluate performance, find bottlenecks, and evaluate user experience. This is a flexible, scalable, and usable approach to capture and replay web transactions, and enable accurate reproduction and measurement of a user's activity while accessing the Internet.

### TECHNICAL FIELD

This invention relates generally to the field of the Internet and Internet browser applications, and more specifically to performance measurement of Internet-based applications.

### BACKGROUND OF THE INVENTION

For many Internet Service Providers (ISPs), web-sites and web-based applications, it is important to be able to measure and accurately reproduce a users activity while the user is connected to the web (or the Internet). Measuring and recording a user's activity, in the form of one or more Internet transactions, is useful for many reasons, including business plan development, security, and optimization applications. In an optimization application, such as managing web-hosting services, service providers require a means for assessing the performance of their web-based applications. These performance measurements can then be used to optimize performance and provide customers with service level reports. A means for collecting these performance measurements requires a test that can record specific transactions (a sequence of links) through a web-based application, and then replay those transactions while taking performance measurements.

In approaching the problem of recording an Internet user's transactions through a web site, several constraints should be considered. The solution should support scripting, including JavaScript, and should support applets embedded on the HTML pages. It should also allow the user to utilize familiar and easy to use browsers. The transactions should provide a means to adequately display the pages associated with a transaction both during recording and replay, allowing for leveragability to both record and play modes. The solution must also support the existing web protocol standards and be capable of running on the majority of commercially available operating systems.

Current methodologies for capturing Internet transactions include using a commercially available web browser to record a user's activity at the graphical level and subsequently replaying the graphical inputs to reproduce the transaction. Other techniques include using the same commercial browser to capture the underlying protocol messages generated between the browser and the Internet for replay later at the protocol (not the browser level). These techniques have several problems. Recording graphical interactions “locks in” use of a particular browser while limiting the number and types of operating systems that can be used. This technique further suffers from the inability to tolerate changes in page layouts. The second approach suffers from the inability to properly evaluate the page content returned because of the lack of browser rendering and script interpretation.

Therefore, there is a need in the art for a method for capturing and replaying Internet application transactions that is independent of the type of operating system and the kind of browser that is used. There is a further need in the art for a method for capturing and replaying Internet application transactions that evaluates the protocol level information and the browser rendering and scripting information.

### SUMMARY OF THE INVENTION

A method and system for capturing and replaying Internet application transactions using an embedded browser. According to the method of the invention, a user begins the process of capturing Internet application transactions by opening a launch page on a client browser. A script on the launch page will redirect the user to a setup page to install a plug-in. The plug-in is then used to install and configure an embedded browser. After the user initiates a recording from a record page, the embedded browser can be used to render and process any web pages that the user accesses. Transactions corresponding to the web pages accessed are stored and at a later time, the embedded browser may be used to replay these transactions.

According to the system of the present invention, a client browser, which is connected to the Internet, contains an embedded browser and a plug-in application. The plug-in application communicates with a web transaction (webtrans) servlet to install and configure the embedded browser. The embedded browser is used to display web pages from a plurality of web servers. The web transaction servlet is also coupled to the Internet, and the servlet provides support files needed by the embedded browser so that the user can record transactions from web pages contained in the plurality of web servers.

At a later time, the user can then playback previously recorded transactions to ensure that the recorded transactions are correct. Web pages required for recording and replaying Internet application transactions are provided to the embedded browser by communication between the plug-in and the web transaction servlet.

The system and method of the present invention allows a user to record web pages written using html and JavaScript, and further allows the user to replay the recorded pages even when the page layout changes or scripting is modified on the page. The system and method of the present invention allows the user to record and replay transactions on a variety of platforms, including Windows NT, 2000, Solaris, and Linux.

In addition to recording and replaying Internet application transactions, a user can replay the captured transaction as a test executing in a measurement gathering framework. This provides the ability to compile detailed measurements, useful in measuring performance, determining bottlenecks, planning optimizations, and gauging user experience interacting with the site under test. The ability to replay Internet application transactions independent of page layout changes or scripting enables the embedded browser to fully re-render the pages of the recorded transaction.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a diagram of a system for capturing and replaying Internet transactions using an embedded browser, according to a certain embodiment of the present invention.

FIG. 2 is a flow diagram of a method for installing a plug-in operable to capture and replay Internet transactions using an embedded browser, according to a certain embodiment of the present invention.

FIG. 3 is a flow diagram of a method for recording Internet transactions using an embedded browser, according to a certain embodiment of the present invention.

FIG. 4 is a flow diagram of a method for creating a new recording of Internet transactions using an embedded browser, according to a certain embodiment of the present invention.

FIG. 5 is a flow diagram of a method for replaying recorded Internet transactions, according to a certain embodiment of the present invention.

FIG. 6 is a flow diagram of a method for compiling measurements of recorded Internet transactions, according to a certain embodiment of the present invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

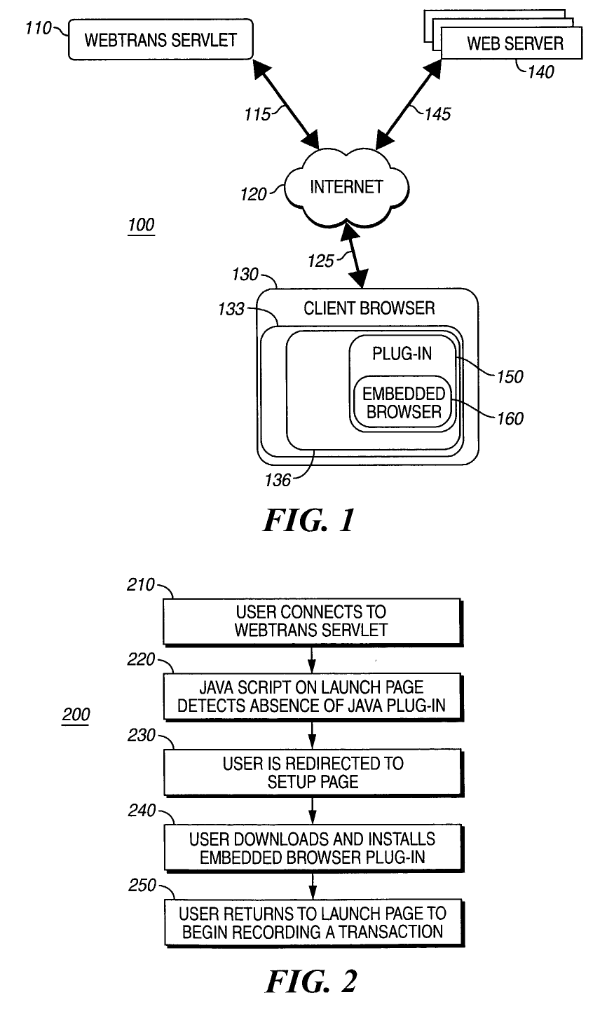

Referring now to FIG. 1, a diagram of a system 100 for capturing and replaying Internet transactions using an embedded browser is shown, according to a certain embodiment of the present invention. Web transaction servlet 110 communicates with client browser 130 and a plurality of web servers 140 in order to provide a user with a client browser plug-in 150 and embedded browser 160. Web transaction servlet communicates using a connection 115 to Internet 120, while the plurality of web servers 140 use a connection 145 to Internet 120. It is noted that one of skill in the art will recognize that Internet 120 could be replaced by an intranet or hybrid network without departing from the spirit and scope of the present invention. Embedded browser 160 is operable to render one or more web pages contained in the plurality of web servers 140 through a plurality of requests for html pages 150. Client browser 130, plug-in 150, and embedded browser 160 send and receive information via a connection to Internet 120. Client browser 130 provides embedded browser 160 with a connection to Internet 120, so that embedded browser 160 can access web pages without requiring browser configuration.

Embedded browser 160 interacts with plug-in 150 to retrieve browser information such as proxy settings, and interacts with client browser 130 in order to communicate control requests relating to the frames displayed within a web page. Embedded browser 160 also interacts with web transaction servlet 110 for requests for support files, plug-ins, http pages, and log updates. Web transaction servlet 110 contains many types of content information, such as applets including those required by third party software, web transaction pages and images, Java plug-ins for one or more supported platforms such as Windows NT, Solaris, Linux, etc., and applet files used under the one or more supported platforms. In a preferred embodiment of the present invention, plug-in 150 also contains a web transaction applet that is operable to send and receive information to web transaction servlet 110 by way of Internet 120.

Two browser pages that are associated with the ability of the system 100 to record and replay Internet application transactions are a launch page 133 and a setup page 136. Launch page 133 is used to start recording transactions, while setup page 136 is used to install plug-in 150 and embedded browser 160. The first time a user accesses the record and replay capability, the user is directed to the setup page 136. One of skill in the art will recognize that other pages specific to controlling the ability of the system 100 to record and replay Internet application transactions may be present without departing from the spirit and scope of the present invention. For example, more than one setup page could be used in order to configure the embedded browser 160 and the plug-in 150, an option page could be used to determine how the embedded browser 160 interacts with the client browser 130, and a plurality of pages could be used to record and replay internet application transactions.

Referring now to FIG. 2, a flow diagram 200 of a method for installing a plug-in 150 operable to capture and replay Internet transactions using embedded browser 160 is shown, according to a certain embodiment of the present invention. The method 200 for installing plug-in 150 starts when a user connects to web transaction servlet 110 (block 210). JavaScript on the launch page 133 of client browser 130 detects the absence of plug-in 150. User is then redirected to setup page 136 (block 230). From the setup page 136, user downloads and installs plug-in 150 for embedded browser 160. User can then return to launch page 133 to begin recording a transaction of the plurality of transactions. It is noted that one of skill in the art will recognize that although plug-in 150 is shown in FIG. 2 as a Sun Java plug-in, an alternative plug-in could be used without departing from the spirit and scope of the present invention.

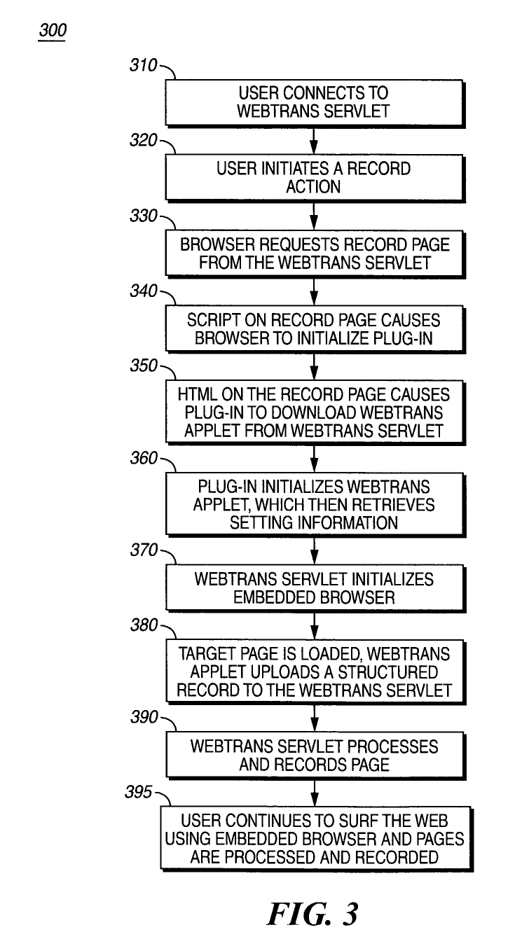

Referring now to FIG. 3, a flow diagram 300 of a method for recording Internet transactions using an embedded browser is shown, according to a certain embodiment of the present invention. To start recording a transaction, a user connects to the web transaction servlet 110 (block 310). User then proceeds to initiate a record from a “new” or edit mode by submitting a transaction name, step name and an initial target page (block 320). Each transaction can be divided into a number of steps, where each step contains one or more pages of the transaction. Client browser 130 requests record page from web transaction servlet 110 (block 330). The record page is organized so that client browser 160 retrieves record pages for a left frame and a right frame from the web transaction servlet 110. In a preferred embodiment of the present invention, the left frame contains the record controls and the right frame contains the record content. A script on the record page causes the client browser 130 to initialize plug-in 150 (block 340). In a preferred embodiment of the present invention, the plug-in 150 is a Sun Java Plug-in, and the script is a JavaScript on the record content frame.

The html on the record content frame causes plug-in 150 to download a web transaction applet from web transaction servlet 110 along with supporting jar files (block 350). Plug-in 150 initializes the web transaction applet, and the web transaction applet then retrieves setting information from the plug-in 150 (block 360). In a preferred embodiment of the present invention, the web transaction applet retrieves an initial target page, the browser type, level of debug of browser output, and type of user interface classes to use. The web transaction applet then initializes embedded browser 160, which begins loading and rendering the initial target page (block 370). Once the initial target page is loaded, web transaction applet uploads a structured record command to the web transaction servlet 110 (block 380). In a preferred embodiment of the present invention, the structured record command is written in XML, and uploaded to web transaction servlet 110 using http. The web transaction servlet 110 then processes and records the page (block 390). In a preferred embodiment of the present invention, web transaction servlet 110 replies to the web transaction applet with a success or failure result. The user may then continue to surf the Internet through the embedded browser and accessed pages are processed and recorded (block 395).

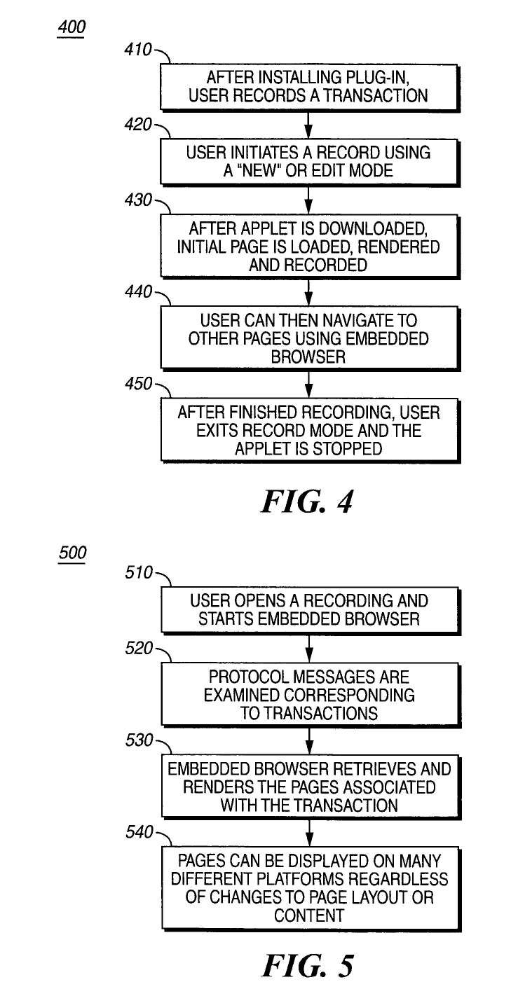

Referring now to FIG. 4, a flow diagram 400 of a method for creating a new recording of Internet transactions using an embedded browser is shown, according to a certain embodiment of the present invention. After installing plug-in 150, a user may record a transaction (block 410). User initiates the record operation using a new or edit mode from launch page 133, as in block 420. After the plug-in 150 is downloaded, an initial page may be loaded using an applet containing embedded browser 160, rendered and recorded (block 430). The embedded browser 160 may then be used to navigate to other web sites (block 440). After the user has finished navigating the Internet, the user exits the record mode and the applet is stopped. In a preferred embodiment of the present invention, one or more record pages may be used to facilitate the recording of transactions corresponding to the web sites accessed.

Referring now to FIG. 5, a flow diagram of a method for replaying recorded Internet transactions 500 is shown, according to a certain embodiment of the present invention. After a user has created a recording and the user has accessed the Internet and recorded a plurality of Internet transactions, the recording can be replayed at a later time. In a preferred embodiment of the present invention, the recording is replayed to determine the correctness of the recorded plurality of Internet transaction. The user first opens the recording and starts embedded browser 160 (block 510). Protocol messages are then examined which correspond to the plurality of Internet transactions (block 520). The embedded browser then retrieves the pages associated with the plurality of transactions, and renders the pages according to the protocol messages and associated page layout information (block 530). Because the plurality of Internet transactions have been recorded using an embedded browser, the plurality of Internet transactions can be replayed on many platforms and under many operating systems (block 540). In a preferred embodiment of the present invention, a number of steps in each transaction of the plurality of transactions and a number of pages per step may be adjusted while replaying the recording. Additionally, the user may changes the dynamic content displayed on one or more pages comprising the plurality of transactions, and add or remove pages comprising the plurality of transactions. These adjustments enable accurate and meaningful measurements of the plurality of transactions to be compiled.

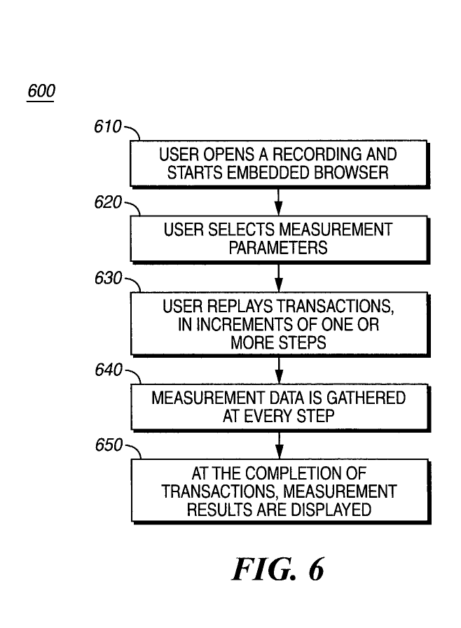

Referring now to FIG. 6, a flow diagram of a method for compiling measurements of recorded Internet transactions 600 is shown, according to a certain embodiment of the present invention. After a user has created a recording, accessed the Internet, recorded a plurality of Internet transactions, and verified the plurality of Internet transactions, the recording can be replayed at a later time. The user first opens a recording and starts embedded browser (block 610). The user then selects measurement parameters to apply to the recording (block 620). In a preferred embodiment of the present invention, the measurement parameters include:

whether the transaction completed successfully,

the total response time for the entire transaction,

per step measurements,

the total response time,

the data transfer time,

the data transfer rate,

whether valid page content was found, and

connection measurements relating to the:

connection time,

server response time,

download time,

number of bytes downloaded from the server,

number of bytes read from cache,

page render time for each page rendered, and

object render time for each object on the page.

The user then replays the plurality of transactions, in increments of one or more steps (block 630). Measurement data is then collected at each step (block 640), and at the completion of the steps comprising the plurality of transactions the measurement results are displayed to the user (block 650). In a preferred embodiment of the present invention, the measurement results are displayed as each step progresses. Additionally, measurement summaries are operable to be displayed at the completion of each step. Note that in a similar manner to the replay shown in FIG. 5, when the user replays the plurality of transactions for measurement purposes as shown in FIG. 6, the protocol message and page layout information are replayed, so that the pages comprising the recording can be rendered as they were recorded.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A system for capturing and replaying Internet application transactions using an embedded browser, comprising:
a client browser, coupled to an Internet;
an embedded browser, coupled to the client browser, said embedded browser operable to replay a plurality of recorded Internet application transactions independent of changes in page layout and client browser configuration;
a web transaction servlet, coupled to the Internet, and operable to provide a plurality of files required for the correct operation of the embedded browser;
a plurality of web servers coupled to the Internet, wherein each web server of the plurality of web servers contains one or more web pages;
a record interface, coupled to the embedded browser, said record interface operable to facilitate recording a plurality of transactions;
a playback interface, coupled to the embedded browser, said playback interface operable to verify the recording of the plurality of transactions; and
a measurement interface, coupled to the embedded browser, said measurement interface operable to compile parameters related to the plurality of transactions.

2. A system in accordance with claim 1, wherein the embedded browser is operable to display browser information using JavaScript.

3. A system in accordance with claim 1, wherein the embedded browser is further coupled to a plug-in, said plug-in coupled to the client browser.

4. A system in accordance with claim 1, where the web transaction servlet further comprises one or more of:
a plurality of support files needed by one or more applets;
a plurality of web transaction builder pages;
Sun's Java plug-ins for a plurality of supported platforms; and
jar files used by the plug-in under a plurality of supported platforms.

5. A system in accordance with claim 1, wherein the embedded browser renders a plurality of transaction pages through the use of a left frame and a right frame of the embedded browser display.

6. A system in accordance with claim 5, wherein the left frame displays one or more transaction control elements.

7. A system in accordance with claim 5, wherein the right frame displays one or more transaction content elements.

8. A system in accordance with claim 7, wherein the one or more transaction content elements include an initial target page, a type of browser to use, a setting for debug output, and a user interface class to use.

9. A system in accordance with claim 2, wherein the plug-in initializes a log update thread to gather and send log update commands to the web transaction servlet on a periodic interval.

10. A system in accordance with claim 9, wherein the periodic interval is 10 seconds.

11. A system in accordance with claim 1, wherein the embedded browser is operable to display one or more of:
a launch page;
a setup page;
one or more record pages; and
one or more replay pages.

12. A system in accordance with claim 11, wherein the one or more record pages are operable to record one or more transactions using one or more of the one or more web pages.

13. A system in accordance with claim 11, wherein the one or more replay pages are operable to replay a plurality of previously recorded transactions.

14. A system in accordance with claim 1, wherein each transaction of the plurality of transactions comprises a plurality of steps, where each step of the plurality of steps comprises a number of the one or more web pages.

15. A system in accordance with claim 14, wherein the playback interface is operable to perform one or more of:
adjust the number of the one or more web pages per each step of the plurality of steps;
delete one or more recorded pages; and
replace one or more instances of dynamically occurring data located within one or more recorded pages.

16. A system in accordance with claim 1, wherein the measurement interface is operable to measure one or more of:
whether a transaction of the plurality of transactions completed successfully;
a total response time for the transaction;
per step measurements;
a total response time;
a data transfer time;
a data transfer rate;
whether valid page content was found; and
one or more connection measurements.

17. A system in accordance with claim 16, wherein the one or more connection measurements are:
a connection time,
a server response time,
a download time,
a number of bytes downloaded from a web server,
a number of bytes read from a cache,
a page render time for each page rendered, and
an object render time for each object on a rendered page.

18. A method for capturing and replaying internet application transactions using an embedded browser, comprising:
a user initially connecting to a web transaction servlet using a client browser;
the client browser obtaining a record page from the web transaction servlet;
processing and recording a plurality of internet application transactions corresponding to one or more web pages visited by the user; and
playing back the one or more of the recorded transactions corresponding to the one or more web pages visited by the user, wherein the recorded transactions are rendered independent of changes in page layout and client browser configuration.

19. A method in accordance with claim 18, wherein while playing back the one or more recorded transactions, the user may perform one or more of:
adjusting the number of the one or more web pages per each step of the plurality of steps, wherein each step represents one or more recorded web pages;
deleting one or more recorded pages; and
replacing one or more instances of dynamically occurring data located within one or more recorded pages.

20. A method in accordance with claim 18, wherein prior to processing and recording the plurality of internet application transactions, the user first creates a new record session.

21. A method in accordance with claim 18, wherein the record page contains script causing the client browser to initialize the embedded browser.

22. A method in accordance with claim 18, where the user initial connect to the web transaction servlet further comprises:
JavaScript on a launch page detecting an absence of a plug-in and redirecting user to a setup page;
User downloading and installing plug-in from the web transaction servlet; and
user proceeding back to launch page to begin a transaction.

23. A method in accordance with claim 18, wherein the user creates the new record session by submitting a transaction name, step name, and an initial target page.

24. A method in accordance with claim 18, wherein the record page contains a left frame and a right frame, said left frame operable to contain control related page information and said right frame operable to contain content related page information.

25. A method in accordance with claim 18, wherein the client browser initializing the embedded browser further comprises:
html on the record page causing an installed plug-in to download a web transaction applet from the web transaction server;
the web transaction applet retrieving setting information from the installed plug-in and parameters specified on the record page; and
the web transaction applet initializing the embedded browser.

26. A method in accordance with claim 18, wherein the setting information includes one or more of
an initial target page;
a type of browser to use;
a setting for debug output; and
a user interface class to use.

27. A method in accordance with claim 18, wherein processing and recording each internet application transaction corresponding to one or more web pages visited by the user further comprising:
loading and rendering a target page;
uploading a structured record command to the web transaction servlet; and
the web transaction servlet processing and recording each page visited and noting success or failure.

28. A method in accordance with claim 18, wherein replaying one or more of the recorded transactions corresponding to the one or more web pages visited by the user further comprising:
opening the recording;
examining a plurality of protocol messages corresponding to the one or more recorded transactions;
extracting the relevant information from the plurality of protocol messages;
using the embedded browser to retrieve and render the one or more pages corresponding to the one or more recorded transactions.

29. A method in accordance with claim 18, further comprising compiling measurement statistics of the one or more recorded transactions.

30. A method in accordance with claim 29, wherein the measurement statistics comprise one or more of:
whether a transaction of the plurality of transactions completed successfully;
a total response time for the transaction;
per step measurements, where each step represents one or more recorded web pages;
a total response time;
a data transfer time;
a data transfer rate;
whether valid page content was found; and
one or more connection measurements.

31. A method in accordance with claim 30, wherein the one or more connection measurements are:
a connection time,
a server response time,
a download time,
a number of bytes downloaded from a web server,
a number of bytes read from a cache,
a page render time for each page rendered, and
an object render time for each object on a rendered page.

32. A method for capturing and replaying internet application transactions using an embedded browser, comprising
a user opening a launch page;
a script on the launch page redirecting user to a setup page to install a plug-in;
user initiating recording a transaction from a record page;
a record page installing an embedded browser and one or more support files;
embedded browser processing a plurality of web pages visited by user and recording a plurality of transactions corresponding to the plurality of web pages visited;
user opening a replay page in the embedded browser and replaying the plurality of transactions corresponding to the plurality of web pages visited, wherein said embedded browser is operable to replay the plurality of transactions independent of changes in page layout and client browser configuration; and
user compiling a plurality of measurements of a plurality of characteristics of the plurality of web pages.

33. A method in accordance with claim 32, wherein installing the plug-in further comprising:
JavaScript on the launch page detecting an absence of the plug-in and redirecting user to the setup page;
User downloading and installing plug-in from a web transaction servlet; and
user proceeding back to launch page to begin a transaction.

34. A method in accordance with claim 32, wherein the user initiates the recording by submitting a transaction name, a step name, and an initial target page.

35. A method in accordance with claim 32, wherein the record page contains a left frame and a right frame, said left frame operable to contain control related page information and said right frame operable to contain content relate page information.

36. A method in accordance with claim 32, wherein installing the embedded browser further comprises:
html on the record page causing an installed plug-in to download a web transaction applet from the web transaction server;
the web transaction applet retrieving setting information from the installed plug-in and parameters specified on the record page; and
the web transaction applet initializing the embedded browser.

37. A method in accordance with claim 36, wherein the setting information includes one or more of
an initial target page;
a type of browser to use;
a setting for debug output; and
a user interface class to use.

38. A method in accordance with claim 32, wherein processing a plurality of web pages visited by user and recording a plurality of transactions further comprising:
loading and rendering a target page;
uploading a structured record command to the web transaction servlet; and
the web transaction servlet processing and recording each page visited and noting success or failure.

39. A method in accordance with claim 32, wherein replaying the plurality of transactions further comprising:
opening the recording;
examining a plurality of protocol messages corresponding to the plurality of recorded transactions;
extracting the relevant information from the plurality of protocol messages;
using the embedded browser to retrieve and render the one or more pages corresponding to the one or more recorded transactions;
performing one or more of:
adjusting the number of the one or more web pages per each step of a plurality of steps;
deleting one or more recorded pages; and
replacing one or more instances of dynamically occurring data located within one or more recorded pages.

40. A method in accordance with claim 32, wherein the plurality of measurements comprise one or more of:
whether a transaction of the plurality of transactions completed successfully;
a total response time for the transaction;
per step measurements, where each step represents one or more recorded web pages;
a total response time;
a data transfer time;
a data transfer rate;
whether valid page content was found; and
one or more connection measurements.

41. A method in accordance with claim 40, wherein the one or more connection measurements are:
a connection time,
a server response time,
a download time,
a number of bytes downloaded from a web server,
a number of bytes read from a cache,
a page render time for each page rendered, and
an object render time for each object on a rendered page.
